(19) United States
(12) Patent Application Publication
(10) Pub. No.: US 2024/0424558 A1
(43) Pub. Date: Dec. 26, 2024

(54) THREE-DIMENSIONAL PRINTING WITH REMOVABLE SUPPORT STRUCTURES

(71) Applicant: Hewlett-Packard Development Company, L.P., Spring, TX (US)

(72) Inventors: John Samuel Dilip Jangam, Palo Alto, CA (US); Thomas Anthony, Palo Alto, CA (US); Ben Pon, Palo Alto, CA (US); Lihua Zhao, Palo Alto, CA (US)

(21) Appl. No.: 18/575,181

(22) PCT Filed: Jul. 9, 2021
(86) PCT No.: PCT/US2021/040995

§ 371 Date: Dec. 28, 2023

(51) Int. Cl. B22F 10/14; B22F 10/43; B33Y 10/00; B33Y 70/10

(52) U.S. Cl. CPC B22F 10/14; B22F 10/43; B22F 2999/00; B33Y 10/00; B33Y 70/10

(57) ABSTRACT

A method of three-dimensional printing can include iteratively applying metal particles having a heat fusion temperature as individual build material layers, and based on a 3D object model, iteratively and selectively applying a metallic binding agent onto the individual build material layers so that the individual build material layers are built up and bound together to form a green-body object. The metallic binding agent includes an aqueous liquid vehicle and metal salt or metal oxide nanoparticles that are thermally reducible to a metal or metal alloy at an elevated metal reducing temperature that is lower than the heat fusion temperature. The method also includes iteratively and selectively applying a polymeric binding agent onto the individual build material layers at an interface between the green-body object and a support structure for the green-body object, leaving a residue at the interface.

### BACKGROUND

Three-dimensional (3D) printing or additive manufacturing are processes used to make three-dimensional solid parts from digital models. 3D printing may be used in rapid product prototyping, mold generation, mold master generation, and short run manufacturing. These techniques are generally additive processes because they involve the application of successive layers of build material. This is unlike other machining processes, which often rely upon the removal of material to create the final part. Some 3D printing methods use chemical binders or adhesives to bind build materials together. Other 3D printing methods involve at least partial sintering, melting, etc., of the build material. For some 3D printing methods, at least partial melting of build material may be accomplished using heat-assisted extrusion, and for some other materials (e.g., polymerizable materials), curing may be accomplished using, for example, ultra-violet light or infrared light.

### BRIEF DESCRIPTION OF THE DRAWINGS

FIG. 1 is a flow diagram illustrating example methods of three-dimensional printing in accordance with the present disclosure;

FIG. 2 is a schematic illustration of example three-dimensional printed objects and support structures in accordance with the present disclosure;

FIG. 3 is a schematic illustration of example three-dimensional printed objects and support structures in accordance with the present disclosure;

FIG. 4 is a schematic illustration of example three-dimensional printed objects and support structures in accordance with the present disclosure; and

FIG. 5 is a flow diagram illustrating non-transitory machine readable storage media in accordance with the present disclosure.

### DETAILED DESCRIPTION

Three-dimensional printing can be an additive process involving the application of successive layers of a particulate build material with a binder agent printed thereon to bind the successive layers of the particulate build material together. In some processes, thermal fusing, melting, sintering, or the like can be utilized to form a green-body object and then a sintered metal three-dimensional physical object. For example, a binder agent can be selectively applied to a layer of particulate build material on a build platform to pattern a selected region of the layer and then another layer of the particulate build material is applied thereon. The binder agent can be applied to another layer of the particulate build material and these processes can be repeated to form a green-body object (also known as a green part) of the 3D printed object that is ultimately formed. The binder agent can be capable of penetrating the layer of the particulate build material onto which it is applied, and/or spreading around an exterior surface of the particulate build material and filling void spaces between particles of the particulate build material. The binder agent can include a binder that can hold the particulate build material of the green-body object together. In some 3D printing methods, the binder agent can include latex which can be adhered to the particulate build material upon coalescence and give the green-body object structural integrity. The green-body object can be moved to a sintering oven, or another sintering device and exposed to heat to sinter the particulate build material of the green-body object together and form the 3D printed object. Strengthening the green-body object prior to sintering can provide for structural integrity of the green-body object, particularly during transfer, which may in some instances, allow for automated part extraction and/or transfer.

Methods of three-dimensional printing can include iteratively applying a particulate build material including from about 80 wt % to about 100 wt % metal particles having a heat fusion temperature as individual build material layers, and based on a 3D object model, iteratively and selectively applying a metallic binding agent onto the individual build material layers so that the individual build material layers are built up and bound together to form a green-body object. The metallic binding agent can include an aqueous liquid vehicle and metal salt or metal oxide nanoparticles that are thermally reducible to a metal or metal alloy at an elevated metal reducing temperature that is lower than the heat fusion temperature. In further detail, based on the 3D object model, the method can include iteratively and selectively applying a polymeric binding agent onto the individual build material layers at an interface between the green-body object and a support structure for the green-body object. The polymeric binding agent can include an aqueous liquid vehicle and polymer binder that decomposes to form a residue at an elevated polymer decomposition temperature that is lower than the heat fusion temperature. The residue forms at the interface between the support structure and the green-body object. In some examples, based on the 3D object model, the support structure can be formed by iteratively and selectively applying the metallic binding agent, the polymeric binding agent, or both onto the individual build material layers. In some examples, the metallic binding agent can be applied to form the green-body object and the support structure, and the polymeric binding agent can be applied at a boundary between the support structure as part of the green-body object, the support structure, or both. In other examples, the metallic binding agent can be applied to form the green-body object and the polymeric binding agent can be applied to form the support structure. The method can include heat fusing the green-body object with the support structure at a temperature at or above the heat fusion temperature ranging from about 500° C. to about 3,200° C. to form a heat fused metal object, where the polymeric binding agent can leave a residue at the interface so that the support structures are not integrated with the heat fused metal object or are removable from attachment to the heat fused metal object. In some examples, the heat fusing can occur in a controlled atmosphere, where the controlled atmosphere can include at least one of vacuum sintering, a gas, or both. The gas can be selected from at least one of argon, argon-hydrogen mixture, nitrogen-hydrogen mixture, diazene, helium, hydrogen, nitrogen, or an admixture thereof. In some examples, the support structure can be printed separately from the green-body object, and the method can further include assembling the support structure with the green-body object prior to heat fusing the green-body object.

A three-dimensional printed object and support structure can include a three-dimensional printed object including multiple fused metal particle layers with metal salt or metal oxide nanoparticles alloyed therewith, and a removable support structure attached to a portion of the three-dimensional printed object. The removable support structure can also include multiple fused metal particle layers. The three-dimensional printed object can also include a residue region at an interface between the support structure and the three-dimensional printed object. The residue region in this example is formed from decomposition of a polymer binder at an elevated polymer decomposition temperature that is lower than a heat fusion temperature of metal particles used to form the multiple fused metal particle layers. In another example, the fused metal particle layers can include elemental metals or metal alloys of chromium, cobalt, copper, iron, magnesium, molybdenum, nickel, niobium, steel, stainless steel, tantalum, tin, titanium, tungsten, zinc, zirconium, or a mixture thereof.

A non-transitory machine readable storage medium can include instructions that, when executed by a processor, cause the processer to determine layers of a support structure for a three-dimensional printed object and layers of a three-dimensional printed object, generate instructions to iteratively and selectively apply a metallic binding agent onto the individual build material layers of the three-dimensional printed object so that the individual build material layers are built up and bound together to form a green-body object, and generate instructions to iteratively and selectively apply a polymeric binding agent onto the individual build material layers at an interface between the green-body object and a support structure for the green-body object. In some examples, the instructions can occur based on a computer generated three-dimensional object model and the instructions include calculating a dispensing volume of the metallic binding agent and the polymeric binding agent to be applied onto a particulate build material at locations based on the three-dimensional object model. In other examples, the processor can further generate instructions to iteratively and selectively apply the metallic binding agent to a central portion of the support structure.

When discussing the method of three-dimensional printing, the three-dimensional printed object and support structure, and/or the non-transitory machine readable storage medium herein, these discussions can be considered applicable to one another whether or not they are explicitly discussed in the context of that example. Thus, for example, when discussing a support structure related to a method of three-dimensional printing, such disclosure is also relevant to and directly supported in the context of the three-dimensional printed object and support structure, the non-transitory machine readable storage medium herein, and vice versa.

Terms used herein will have the ordinary meaning in their technical field unless specified otherwise. In some instances, there are terms defined more specifically throughout the specification or included at the end of the present specification, and thus, these terms can have a meaning as described herein.

### Methods of Three-Dimensional Printing

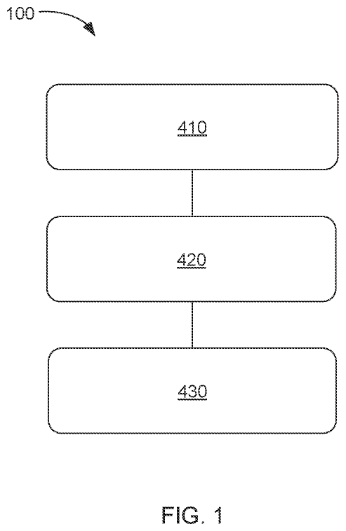

A flow diagram of example methods 100 of three-dimensional printing are illustrated in FIG. 1, and can include iteratively applying 110 a particulate build material as individual layers to a powder bed. The particulate build material can include from about 80 wt % to 100 wt % metal particles which can have a heat fusion temperature. Based on a three-dimensional object model, the method can further include iteratively and selectively applying 120 a metallic binding agent onto individual layers of the particulate build material so that individual layer build material layers can be built up and bound together to form a green-body object. The metallic binding agent can include an 20 aqueous liquid vehicle and metal salt or metal oxide nanoparticles that are thermally reducible to a metal or metal alloy at an elevated metal reducing temperature that can be lower than the heat fusion temperature. Furthermore, based on a 3D object model, the method can include iteratively and selectively applying 130 a polymeric binding agent onto the individual build material layers at an interface between the green-body object and a support structure for the green-body object. The polymeric binding agent can include an aqueous liquid vehicle and a polymer binder that can decompose to form a residue at an elevated polymer decomposition temperature that can be lower than the heat fusion temperature. The residue in this example forms at the interface between the support structure and the green-body object, so that the support structure can be removed from the object after heat fusion of the green body object to form the fused metal object.

The green-body object, can be formed by printing a binding agent selectively and iteratively onto layers of the particulate build material. In some examples, the binding agent applied thereto can include the metallic binding agent. In other examples, the binding agent applied thereto can include a combination of the metallic binding agent and the latex binding agent. The latex binding agent may be applied during formation of the green-body object throughout the green-body object or at select locations of the green-body object. For example, the latex binding agent may be applied to the particulate build material at a location where the green-body object and the support structure interface.

In some examples, the support structure can be formed by iteratively and selectively applying a binding agent. The metallic binding agent and/or the polymeric binding agent can be applied to the particulate build material at a location of the support structure. The support structure can be formed of both the metallic binding agent and the polymeric binding agent, in some examples. A support structure including both metallic binding agent and polymeric binding agent may be stronger than a support structure formed completely of polymeric binding agent and the particulate build material. A support structure may also be formed from the polymeric binding agent and the particulate build material, without the metallic binding agent.

During three-dimensional printing the metallic binding agent may be applied to form the green-body object and the support structure. The polymeric binding agent may be applied at a boundary between the support structure as part of the green-body object, the support structure, or both. In other examples, the polymeric binding agent can be applied at an interface region between the green-body object and the support structure.

The green-body object and the support structure can be printed separately or can be printed at the same time. For example, the green-body object can be printed along with the support structure in the layer by layer printing. The green-body object can be printed at a separation distance from the support structure in the same powder bed at the same time or at different times and/or in different powder beds. The support structure can be combined with the green-body object prior to heat fusing. The green-body object and the support structure can be printed together at the same time and the support structure can be printed in a layer by layer process at the location where the green-body object is susceptible to deformation during heat fusing. For example, a support structure can be printed or placed at an area of an overhang, e.g., a cantilever, bridge, suspended opening, etc. of the green-body object that may be subject to sagging without presence of a support structure.

The method of layering, selectively applying a metallic binding agent, and a polymeric binding agent can be repeated until all the layers of a green-body object and a support structure are formed. For example, the particulate build material can be spread, a binding agent applied, and a build platform can be dropped a distance of 5 μm to 1 mm, which can correspond to the thickness of a printed layer of the three-dimensional object, so that another layer of the particulate build material can be added again thereon to receive another application of the binding agent, and so forth. Once the green-body object and support structure are formed, they can be removed from the powder bed and placed in an oven for heat fusing. The heat fusing of the green-body object with the support structure can occur at a temperature at or above the heat fusion temperature of the particulate build material. In some examples, the heat fusing can occur at a temperature ranging from about 500° C. to about 3,200° C., from about 1,000° C. to about 3,000° C., from about 1,500° C. to about 2,500° C., or from about 2,000° C. to about 3,200° C. to form a heat fused metal object. The heat fusing can occur in a controlled atmosphere. The controlled atmosphere can include at least one of vacuum sintering, a gas, or both. The gas may be selected from at least one of argon, argon-hydrogen mixture, diazene, helium, hydrogen, nitrogen, nitrogen-hydrogen mixture, or an admixture thereof. In some examples, the oven can be vacuum sintered and gas can be pumped in multiple times to minimize or eliminate an oxygen content therein. A controlled atmosphere may be used to minimize oxidation during fusing of the metal particles and can improve an overall strength of the fused three-dimensional object.

During heat fusing the polymeric binding agent can break down and burn off. The polymeric binding agent can also leave a residue at an interface between the green-body object and the support structure. This residue can prevent integration of the heat fused metal object and the support structure. The support structure can be removable from the heat fused metal object at the location of the residue.

In some examples, the support structure can be removed from the three-dimensional printed object following heat fusing. The support structure may be removed by minimal force due to the residue and minimal to no fusing between the support structure and the three-dimensional printed object. In some examples, the removing can occur with from about 1 to about 5 MPa of pressure. In other examples, the removing can occur by sand blasting.

### Three-Dimensional Printed Objects and Support Structures

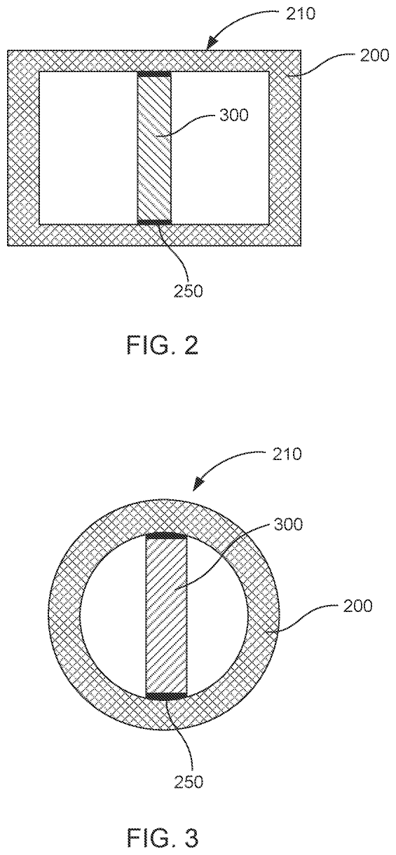

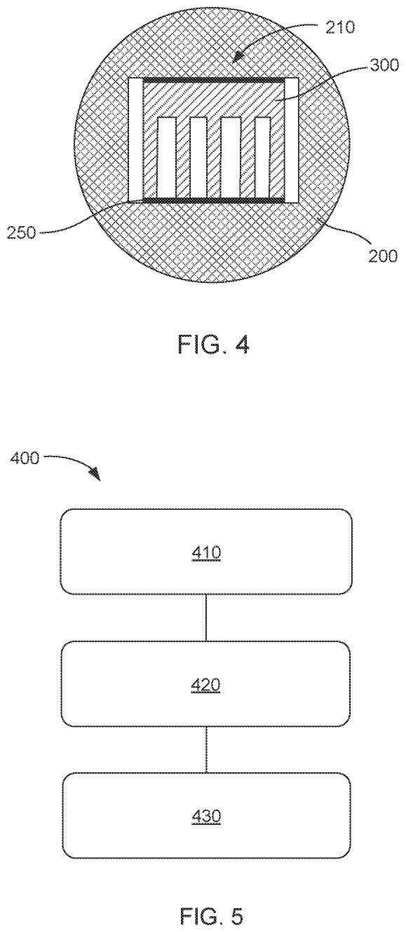

Three-dimensional printed objects and support structures can be formed as described herein. More specifically, as shown in FIGS. 2-4, three-dimensional printed objects 200 can be supported during heat fusing of green body objects using removable support structures 300 of various configurations. The removable support structures and the three-dimensional printed objects can both be formed from multiple fused metal particle layers using metallic binding agent and/or polymeric binding agent, provided the interface 250 is formed from polymeric binding agent. The support structures can be shaped and sized to support a portion of the three-dimensional printed object during the heat fusing process. In some examples, the support structure can support an overhang such as illustrated in FIG. 2 where a bridge or span 210 portion is supported by the support structure. Alternatively, the bridge or span portion can be arcuate, such as that shown in FIG. 3. In other examples, the support structure may act as a support for the three-dimensional object, but can also be removable to intact to act as a useable three-dimensional object as well, as shown in FIG. 4 where both tube-shaped object with a square open channel is shown, as well as a comb-like structure that doubles as bot the support structure and as a second three-dimensional object. In this particular example, the support structure would include metallic binding agent which would promote stronger sintering and density relative to that at the interface where polymeric binding agent is used in the absence of the metallic binding agent. These examples are not intended to be limiting, as the support structure may be sized and shaped to support any structure or overhang of a green body object that may be deformed or sag during heat fusion during the sintering process, for example. Overhangs may include cantilevered portions, bridges or spans, thin portions, openings, etc. In these examples, residue regions 250 can be located at an interface between the support structure and the three-dimensional printed object. The residue region can be formed from decomposition of a polymeric binding agent at an elevated polymer decomposition temperature lower than a heat fusion temperature of metal particles of the fused metal particle layers.

The support structure can improve the three-dimensional printed object by preventing or minimizing deformation of the green-body object during heat fusing. In some examples, a green-body object can include a portion that can be subject to deformation during heat fusing and formation of the three-dimensional printed object. The portion that can be subject to deformation following fusing can have a deformation of less than 3° of deflection when a comparable three-dimensional printed object, including the portion subject to deformation which was heat fused without a support structure, can have a deformation of more than 5° of deflection. In some examples, the portion of the three-dimensional printed object can have a deformation of less than 2°, less than 1°, or can have no visible deflection as a result of the support structures used during heat fusing.

### Non-transitory Machine Readable Storage Media

Non-transitory machine-readable storage media 400 is shown by example in FIG. 5, and can include instructions that when executed by a processor can determine 410 a layer of a support structure for a three-dimensional printed object and a layer of a three-dimensional printed object, generate 420 instructions to iteratively and selectively apply a metallic binding agent onto the individual build material layers so that the individual build material layers are built up and bound together to form a green-body object, and generate 430 instructions to iteratively and selectively apply a polymeric binding agent onto the individual build material layers at an interface between the green-body object and a support structure for the green-body object.

The non-transitory, machine-readable storage medium (e.g., computer/processor-readable) can provide for the storage of machine-readable coded program instructions, data structures, program instruction modules, JDF (job definition format), and other data and/or instructions executable by a processor of a fluid ejector. In some examples, the non-transitory machine-readable storage medium can include computing components such as a processer (CPU), memory such as volatile components (RAM) and nonvolatile components (ROM, hard disc, optical disc, CD-ROM, magnetic tape, flash memory, and the like), circuitry, and the like.

A controller in combination with a processor can receive the user input via a user interface relating to a location of the binding agent and an amount of the binding agent to be applied to the particulate build material. A user interface can enable a user to provide the various user inputs relating to the any of a number of parameters based on factors such as the particulate build material type, a particulate build material particle size, a particulate build material layer thickness, a concentration of the binder in the binding agent, or a combination thereof. Or the user could enter a code or print mode that coordinates with these parameters that may be know to the printing device without entering all of these parameters manually. Either way, the processor can calculate a dispense volume of the binding agent, or other fluid agent, that may be applied, based on these or other parameters. For example, based on the particulate build material particle morphology, particle size distribution (by volume), space between particles, thickness of individual layers, etc., the controller can calculate or can be pre-programmed to apply an amount of binding agent that is sufficient to bind the build material layer together and to a previously applied layer of the green body object.

In some examples, the instructions can occur based on a computer generated three-dimensional object model. In some examples the instructions can include designating a location where successive layers of binding agent should be applied. The instructions can include instructions to iteratively and selectively apply a metallic binding agent to an area of the layer of a green-body object or an area of a layer of the green-body object and an area of a layer of the support structure. In an example, the instructions can include iteratively and selectively applying a metallic binding agent to a central portion of the support structure in addition to the layer of the green-body object. In some examples, the instructions can include instructions to iteratively and selectively apply a polymeric binding agent to an interface between a green-body object and a support structure. The polymeric binding agent can be applied to form a portion of the support structure, the entire support structure, or a portion of the green-body object where the green-body object meets the support structure. When the polymeric binding agent is applied to a portion of the support structure or the green-body object at a portion that meets the support structure, the polymeric binding agent can be applied to an interface area between the green-body object and the support structure.

In some examples, the instructions can include calculating a dispensing volume of the metallic binding agent, the polymeric binding agent, or the combination thereof to be applied to a particulate build material. For example, the instructions can include designating an amount of the metallic binding agent to be applied to the particulate build material. The instructions can designate an amount of metallic binding agent to be applied such that a metal salt or oxide nanoparticles applied can range from about 0.10 g per cm³ of particulate build material to about 0.30 g per cm³ of particulate build material. The instructions can include designating an amount of polymeric binding agent to be applied to the particulate build material. The instructions can designate an amount of polymeric binding agent to be applied such that the polymer binder applied can range from about 0.05 g per cm³ of particulate build material to about 0.20 g per cm³ of particulate build material.

### Particulate Build Materials

The particulate build material can include from about 80 wt % to 100 wt %, from about 90 wt % to 100 wt %, from about 95 wt % to 100 wt %, or from about 99 wt % to 100 wt % metal particles, based on a total weight of the particulate build material. In an example, the metal particles can be an elemental metal, such as elemental transition metals. Examples can include at least one of chromium, cobalt, copper, gold, iron, magnesium, molybdenum, nickel, silver, tantalum, titanium, tungsten, tungsten carbide, vanadium, etc. The metal particles can also be aluminum (which is not a transition metal), or can be an alloy of multiple metals or can include a metalloid(s). Accordingly, the metal particles can include an alloy or admixture selected from aluminum, chromium, cobalt, copper, gold, iron, magnesium, molybdenum, nickel, silver, tantalum, titanium, tungsten, tungsten carbide, or vanadium. In some examples, the alloy can be steel or stainless steel. Even though steel includes carbon, it is still considered to be metal in accordance with examples of the present disclosure because of its metal-like properties. The metal particles can be an admixture of any of these materials. In some examples, the metal particles include elemental metals or metal alloys of nickel, iron, copper, steel, stainless steel, magnesium, titanium, zinc, tin, cobalt, chromium, tungsten, tantalum, zirconium, niobium, molybdenum, or a mixture thereof. In other examples, the metal particles can include copper.

The metal particles can exhibit good flowability and can have a shape type that can be spherical, irregular spherical, rounded, semi-rounded, discoidal, angular, subangular, cubic, cylindrical, or any combination thereof, to name a few. In some examples, the metal particles can include spherical particles, irregular spherical particles, rounded particles, or other particle shapes that have an aspect ratio from 1.5:1 to 1:1, from 1.2:1, to 1:1. In some examples, the shape of the metal particles can be uniform or substantially uniform, which can allow for relatively uniform melting or sintering of the particulates after the three-dimensional green part is formed and heat fused in a sintering or annealing oven, for example.

The particle size distribution can vary. As used herein, particle size can refer to a value of the diameter of spherical particles or, in particles that are not spherical, can refer to the equivalent spherical diameter of that particle. The particle size can be in a Gaussian distribution or a Gaussian-like distribution (or normal or normal-like distribution). Gaussian-like distributions are distribution curves that can appear Gaussian in distribution curve shape, but which can be slightly skewed in one direction or the other (toward the smaller end or toward the larger end of the particle size distribution range). In these or other types of particle distributions, the particle size can be characterized in one way using the 50th percentile of the particle size, sometimes referred to as the “D50” particle size. For example, a D50 value of about 25 μm means that about 50% of the particles (by volume) have a particle size greater than about 25 μm and about 50% of the particles have a particle size less than about 25 μm. Volume-weighted particles sizes (or particle size distribution by volume) can be determined using a high resolution scanning electron microscope. For example, particle size distribution analysis may include using an optical image analysis tool, such as a Camsizer™ X2 from Microtrac MRB (Japan). Whether the particle size distribution is Gaussian, Gaussian-like, or otherwise, the particle size distribution can be expressed in terms of D50 particle size, which may usually approximate average particle size, but may not be the same. In examples herein, the particle size ranges can be modified to “average particle size,” providing sometimes slightly different size distribution ranges. In accordance with this the metal particles can have a D50 particle size distribution value that can range from about 2 μm to about 150 μm, from about 5 μm to about 125 μm, or from about 50 μm to about 100 μm. In other examples, the metal particles can have a D10 particle size distribution value that can range from about 1 μm to about 125 μm, from about 1 μm to about 100 μm, or from about 2 μm to about 125 μm. In some examples, the D90 particle size distribution value for the metal particles can range from about 2.5 μm to about 200 μm or from about 4 μm to about 150 μm.

The metal particles can be produced using any manufacturing method. The metal particles may be manufactured by a gas atomization process. During gas atomization, a molten metal is atomized by inert gas jets into fine metal droplets that cool while falling in an atomizing tower. Gas atomization can allow for the formation of mostly spherical particles. In other examples, the metal particles can be manufactured by a liquid atomization process.

The particulate build material can include components other than metal particles. For example, the particulate build material can include polymer particles, ceramic particles, or a combination thereof. The particulate build material may also include one or more of flow additives, antioxidants, inorganic filler, or any combination thereof. Typically, an amount of any of these or other similar components can be at about 20 wt % or less and the additives, antioxidants, inorganic filler, and the like can be at about 5 wt % or less. Example flow additives can include fumed silica. Example antioxidants can include hindered phenols, phosphites, thioethers, hindered amines, and/or the like. Example inorganic fillers can include particles such as alumina, silica, fibers, carbon nanotubes, cellulose, glass beads, glass fibers, and/or the like. Some additives may be found in multiple categories of additives, e.g., fumed silica can be a flow additive as well as a filler.

### Fluid Ejectors

A fluid ejector can be operable to selectively deposit jettable fluid(s), such as a metallic binding agent, a polymeric binding agent, or the like, onto the particulate build material to form individually patterned object layers. Fluid ejector(s) are capable of selectively applying the jettable fluid(s). For example, the fluid ejector can be a printhead such as a digital fluid ejector, such as an inkjet printhead, e.g., a piezo-electric printhead, a thermal printhead, a continuous printhead, etc. The fluid ejector could likewise be a sprayer, a dropper, or other similar structure for applying the metallic binding agent, the polymeric binding agent, or the like to the particulate build material. In some examples, the fluid ejector can be located on a carriage track, but could be supported by any of a number of structures. The fluid ejector may be operable to move back and forth over the particulate build material along the carriage track when positioned over or adjacent to a powder bed of a build platform.

In some examples, the method and the non-transitory, machine-readable storage medium can utilize a first fluid ejector and a second fluid ejector that can be in the same unit or can be in units separate from one another. For example, a first printhead can apply the metallic binding agent and a second printhead can apply the polymeric binding agent. In other examples, the first fluid ejector and the second fluid ejector can be separate nozzles in a single printhead.

### Binding Agents

The methods of three-dimensional printing, the three-dimensional printed object and support structure, and the use of the non-transitory machine readable storage medium can include the use of a metallic binding agent, a polymeric binding agent, or a combination thereof. The binding agent can include binder particles and an aqueous liquid vehicle. The term “binder particles” can include any material used to physically bind separate metal particles together or facilitate adhesion to a surface of adjacent metal particles in order to prepare a green part or green-body object in preparation for subsequent heat-fusing, e.g., sintering, annealing, melting, etc. During three-dimensional printing, a binding agent can be applied to the particulate build material on a layer by layer basis. The aqueous liquid vehicle of the binding agent can be capable of wetting a particulate build material and the binder particles can move into vacant spaces between metal particles of the particulate build material, for example. The binding agent can provide binding to the particulate build material upon application, or in some instances, can be activated after application to provide binding. The binder particles can be activated or cured by heating the binder particles (which may be accomplished by heating an entire layer of the particulate build material on a portion of the binding agent which has been selectively applied).

Metallic binding agents can include an aqueous liquid vehicle and a metal salt or metal oxide nanoparticles that can be thermally reducible to a metal or metal alloy at an elevated metal reducing temperature that can be lower than the heat fusion temperature of the metal particles of the particulate build material. The metal or metal alloy can be in the form of a reducible-metal compound binder. To illustrate, if stainless steel is used as metal build particles in the stainless steel build material, or as the secondary metal alloy in the shaping composition, the reducible-metal compound binder may be an aluminum oxide, cerium oxide, a chromium oxide, a copper oxide, an iron oxide, lanthanum oxide, a magnesium oxide, a manganese oxide, a niobium oxide, silicon dioxide, a silver oxide, a tin oxide, a titanium oxide, yttrium oxide, zinc oxide, zirconium dioxide, salts thereof, or mixtures thereof. In some examples, the reducible-metal compound binder can be a copper oxide. The reducible-metal compound binder can be reduced by hydrogen released from a thermally activated reducing agent in some examples. More general examples of reducible-metal compound binders can include metal oxides (from one or multiple oxidation states), such as a copper oxide. e.g., copper (I) oxide or copper (II) oxide; an iron oxide, e.g., iron (II) oxide or iron (III) oxide; an aluminum oxide, a chromium oxide, e.g., chromium (IV) oxide; titanium oxide, a silver oxide, zinc oxide, etc. As a note, due to variable oxidation states of transition metals, they can form various oxides in different oxidation states, e.g., transition metals can form oxides of different oxidation states. Other examples can include organic or inorganic metal salts. In particular, inorganic metal salts that can be used include metal bromides, metal chlorides, metal nitrates, metal sulfates, metal nitrites, metal carbonates, or a combination thereof. Organic metal salts can include chromic acid, chrome sulfate, cobalt sulfate, potassium gold cyanide, potassium silver cyanide, copper cyanide, copper nitrate, copper sulfate, nickel carbonate, nickel chloride, nickel fluoride, nickel nitrate, nickel sulfate, potassium hexahydroxy stannate, sodium hexahydroxy stannate, silver cyanide, silver ethansulfonate, silver nitrate, sodium zincate, stannous chloride (or tin (II) chloride), stannous sulfate (or tin (II) sulfate, zinc chloride, zinc cyanide, tin methansulfonate, for example. In other examples, the reducible-metal compound binder can be a copper nitrate binder. In some instances, the reducible-metal compound binder can be in the form of a nanoparticle, and in other instances, the reducible-metal compound binder can be disassociated or dissolved in the aqueous liquid vehicle. As particles, the reducible-metal compound binder can have a D50 particle size from about 10 nm to about 10 μm, from about 10 nm to about 5 μm, from about 10 nm to about 1 μm, from about 15 nm to about 750 nm, or from about 20 nm to about 400 nm. The metal salt or oxide nanoparticles can be present in the metallic binding agent at from about 20 wt % to about 65 wt %, from about 30 wt % to about 50 wt %, from about 40 wt % to about 60 wt %, or from about 20 wt % to about 60 wt %.

The metal salt or oxide nanoparticles can be reducible as a result of introduced atmosphere with a reducing agent, and/or can be thermally activated, for example. Thermally activated reducing agent that can be used may be sensitive to elevated temperatures. Example thermally activated reducing agents can include hydrogen (H₂), lithium aluminum hydride, sodium borohydride, a borane (e.g., diborane, catecholborane, etc.) sodium hydrosulfite, hydrazine, a hindered amine, 2-pyrrolidone, ascorbic acid, a reducing sugar (e.g., a monosaccharide), diisobutylaluminium hydride, formic acid, formaldehyde, or mixtures thereof. The choice of reducing agent can be such that it is thermally activated at a temperature, or can be introduced at a temperature where reduction of the metal binder may be desired. By way of example, if considering using a metal oxide nanoparticle as the binder, there may be metal oxides that are stable (or relatively unreactive) at room temperature, but upon application of heat, e.g., 200° C. to 1,000° C. or 250° C. to 1,000° C. or from 300° C. to 700° C., a redox-reaction can result in the production of the pure metal or metal alloy. As an example, mercury oxide or silver oxide can be reduced to their respective elemental metal by heating to about 300° C., but the presence of a reducing agent may allow the reaction to occur at a lower temperature, e.g., about 180° C. to about 200° C. Oxides of more reactive metals like zinc, iron, copper, nickel, tin, or lead may likewise be reduced simply in the presence of a reducing agent, so the reducing agent can be introduced into the fusing oven or furnace at a time when binding properties may be beneficial. Reducing agents, whether thermally activated or reactive without added temperature, can be capable of providing hydrogen moieties completing the redox-reaction at elevated temperatures in accordance with examples of the present disclosure.

In some examples, the metallic binding agent can further include from about 0.1 wt % to about 5 wt % or from about 1 wt % to about 3 wt % of an oxidation protection agent. The oxidation protection agent can act to dissolve an outermost surface layer of the metal particles in the particulate build material and can reduce an amount of the oxidation build-up on a surface of the metal particles. In some examples, the oxidation production agent can include at least one of ammonium dihydrogen phosphate, acetic acid, phosphoric acid, carbonic acid, hydrocyanic acid, or a mixture thereof. In other examples, the oxidation protection agent can include at least one of ammonium dihydrogen phosphate, acetic acid, or a mixture thereof.

Polymeric binding agents, on the other hand, can include an aqueous liquid vehicle and a polymer binder. The polymer binder can include polymer particles that can decompose leaving a residue at an elevated polymer decomposition temperature that can be lower than the heat fusion temperature of the metal particles of the particulate build material The polymer binder can include latex particles that can be selected from acrylate-containing latex, methacrylate-containing latex, styrene-containing latex, polyurethane latex, or a mixture thereof. The latex particles can include copolymerized monomers that can be from monomers, such as styrene, p-methyl styrene, α-methyl styrene, methacrylic acid, acrylic acid, acrylamide, methacrylamide, 2-hydroxyethyl acrylate, 2-hydroxyethyl methacrylate, 2-hydroxypropyl acrylate, 2-hydroxypropyl methacrylate, methyl methacrylate, hexyl acrylate, hexyl methacrylate, butyl acrylate, butyl methacrylate, ethyl acrylate, ethyl methacrylate, 2-ethylhexyl acrylate, 2-ethylhexyl methacrylate, propyl acrylate, propyl methacrylate, octadecyl acrylate, octadecyl methacrylate, stearyl methacrylate, vinylbenzyl chloride, isobornyl acrylate, tetrahydrofurfuryl acrylate, 2-phenoxyethyl methacrylate, benzyl methacrylate, benzyl acrylate, ethoxylated nonyl phenol methacrylate, ethoxylated behenyl methacrylate, polypropyleneglycol monoacrylate, isobornyl methacrylate, cyclohexyl methacrylate, cyclohexyl acrylate, t-butyl methacrylate, n-octyl methacrylate, lauryl methacrylate, tridecyl methacrylate, alkoxylated tetrahydrofurfuryl acrylate, isodecyl acrylate, isobornyl methacrylate, isobornyl acrylate, dimethyl maleate, dioctyl maleate, acetoacetoxyethyl methacrylate, diacetone acrylamide, N-vinyl imidazole, N-vinylcarbazole, N-vinyl-caprolactam, or combinations thereof. In some examples, the latex particles can include an acrylic. In other examples, the latex particles can include 2-phenoxyethyl methacrylate, cyclohexyl methacrylate, cyclohexyl acrylate, methacrylic acid, combinations thereof, derivatives thereof, or mixtures thereof. In other examples, the latex particles can include styrene, methyl methacrylate, butyl acrylate, methacrylic acid, combinations thereof, derivatives thereof, or mixtures thereof.

The polymer binder particles can have a D50particle size that can range from about 100 nm to about 1 μm. In other examples, the polymer particles can have a D50 particle size that can range from about 150 nm to about 300 nm, from about 200 nm to about 500 nm, or from about 250 nm to about 750 nm. The polymer binder can be present in the polymeric binding agent at from about 5 wt % to about 30 wt %, from about 10 wt % to about 20 wt %, from about 20 wt % to about 30 wt %, from about 12 wt % to about 16 wt %, or from about 15 wt % to about 25 wt % in the polymeric binding agent.

The polymer binder can also include a water-soluble polymer as a secondary component. In some examples, incomplete decomposition of the water-soluble polymer may leave a residue within selected patterned areas of the build material, thereby impeding sintering and facilitating removal of support structures. Nevertheless, this type of polymer may be used in quantities that fall within acceptable tolerances for the fused metal three-dimensional object formed. Examples of water-soluble polymers that can be used include polyvinyl alcohol, polyvinyl pyrrolidone, polyacrylic acid, polyethylene glycol, polyacrylamide, polyethylene oxide, polysaccharides, or a combination thereof.

In some examples, the polymeric binding agent can further include secondary components other than the polymer binder that can decompose leaving a residue at secondary component decomposition temperature from about 100° C. to about 500° C. For example, the polymeric binding agent can further include silica nanoparticles, alumina nanoparticles, carbon nanoparticles or a combination thereof. Carbon can be in the form of nanoparticles, nanowires, or graphene platelets. The nanoparticles can assist in releasing the support structure from a three-dimensional printed object. The nanoparticles can have a D50 particle size that can range from about 10 nm to about 500 nm, from about 50 nm to about 250 nm, from about 100 nm to about 300 nm, from about 200 nm to about 400 nm, or from about 50 nm to about 150 nm. The nanoparticles can be present at from about 0.01 wt % to about 5 wt %, from about 0.1 wt % to about 5 wt %, from about 0.5 wt % to about 2.5 wt %, from about 1 wt % to about 3 wt %, or from about 2 wt % to about 4 wt %.

### Aqueous Liquid Vehicles

As used herein, the term “aqueous liquid vehicle” refers to the liquid in the metallic binding agent, the polymeric binding agent, and/or other fluid agents that may be present. The aqueous liquid vehicle may include water alone or in combination with a variety of additional components. The aqueous liquid vehicle may be water or may include water and organic co-solvent, for example. Examples of components that may be included, in addition to water, may include organic co-solvent, surfactant, buffer, antimicrobial agent, anti-kogation agent, chelating agent, buffer, etc. In an example, the aqueous liquid vehicle includes water and organic co-solvent. In another example, the aqueous liquid vehicle includes water, organic co-solvent, and a surfactant. In yet another example, the aqueous liquid vehicle includes water, organic co-solvent, surfactant, and antimicrobial agent. In a further example, the aqueous liquid vehicle includes water, organic co-solvent, surfactant, antimicrobial agent, and a chelating agent.

The aqueous liquid vehicle can include water that may be deionized, for example. In some examples, water can be present in the metallic binding agent, the polymeric binding agent, and/or other fluid agents at a weight percentage that can vary from about 30 wt % to about 90 wt %, from about 50 wt % to about 80 wt %, or from about 70 wt % to about 90 wt %.

Some examples of organic co-solvent(s) that may be added to the aqueous liquid vehicle can include ethanol, methanol, propanol, acetone, tetrahydrofuran, hexane, 1-butanol, 2-butanol, tert-butanol, isopropanol, propylene glycol, triethylene glycol, methyl ethyl ketone, dimethylformamide, 1,4-dioxone, acetonitrile, 1,2-butanediol, 1-methyl-2,3-propanediol, 2-pyrrolidone, glycerol, 2-phenoxyethanol, 2-phenylethanol, 3-phenylpropanol, or a combination thereof. In other examples, the co-solvent can include 2-pyrrolidonone. Whether a single co-solvent is included or a combination of co-solvents are included, a total amount of organic co-solvent(s) in the metallic binding agent, the polymeric binding agent, and/or other fluid agents can range from about 5 wt % to about 50 wt %, from about 10 wt % to about 50 wt %, from about 15 wt % to about 45 wt %, from about 30 wt % to about 50 wt %, from about 5 wt % to about 35 wt %, or from about 5 wt % to about 40 wt %, based on a total weight percentage of the fluid agent.

Examples of surfactants can include a non-ionic surfactant, a cationic surfactant, and/or an anionic surfactant. The fluid agent can include an anionic surfactant. In other examples, the fluid agent can include a non-ionic surfactant. In still another example, the fluid agent can include a blend of both anionic and non-ionic surfactant. Example non-ionic surfactants that can be used include self-emulsifiable, nonionic wetting agents based on acetylenic diol chemistry (e.g., SURFYNOL® SEF from Air Products and Chemicals, Inc., USA), a fluorosurfactant (e.g., CAPSTONE® fluorosurfactants from DuPont, USA), or a combination thereof. In other examples, the surfactant can be an ethoxylated low-foam wetting agent (e.g., SURFYNOL® 440, SURFYNOL® 465, or SURFYNOL® CT-111 from Air Products and Chemical Inc., USA) or an ethoxylated wetting agent and molecular defoamer (e.g., SURFYNOL® 420 from Air Products and Chemical Inc., USA). Still other surfactants can include wetting agents and molecular defoamers (e.g., SURFYNOL® 104E from Air Products and Chemical Inc., USA), alkylphenylethoxylates, solvent-free surfactant blends (e.g., SURFYNOL® CT-211 from Air Products and Chemicals, Inc., USA), water-soluble surfactant (e.g., TERGITOL® TMN-6, TERGITOL® 15S7, and TERGITOL® 15S9 from The Dow Chemical Company, USA), or a combination thereof. In other examples, the surfactant can include a non-ionic organic surfactant (e.g., TEGO® Wet 510 from Evonik Industries AG, Germany), a non-ionic secondary alcohol ethoxylate (e.g., TERGITOL® 15-S-5, TERGITOL® 15-S-7, TERGITOL® 15-S-9, and TERGITOL® 15-S-30 all from Dow Chemical Company, USA), or a combination thereof. Example anionic surfactants can include alkyldiphenyloxide disulfonate (e.g., DOWFAX® 8390 and DOWFAX® 2A1 from The Dow Chemical Company, USA), and oleth-3 phosphate surfactant (e.g., CRODAFOS™ N3 Acid and CRODAFOS™ 03A both from Croda, UK). Example cationic surfactants that can be used can include dodecyltrimethylammonium chloride, hexadecyldimethylammonium chloride, or a combination thereof. In some examples, the surfactant (which may be a blend of multiple surfactants) may be present in the metallic binding agent, the polymeric binding agent, and/or other fluid agents at an amount ranging from about 0.01 wt % to about 2 wt %, from about 0.05 wt % to about 1.5 wt %, or from about 1 wt % to about 2 wt %.

In some examples, the aqueous liquid vehicle may further include a chelating agent, an antimicrobial agent, a buffer, or a combination thereof. While the amount of these may vary, if present, these can be present in the metallic binding agent, the polymeric binding agent, and/or other fluid agents at a total amount ranging from about 0.001 wt % to about 20 wt %, from about 0.05 wt % to about 10 wt %, or from about 0.1 wt % to about 5 wt %.

Examples of suitable chelating agents can include disodium ethylene-diaminetetraacetic acid (EDTA-Na), ethylene diamine tetra acetic acid (EDTA), and methyl-glycinediacetic acid (e.g., TRILON® M from BASF Corp., Germany). If included, whether a single chelating agent is used or a combination of chelating agents is used, the total amount of chelating agent(s) in the metallic binding agent, the polymeric binding agent, and/or other fluid agents may range from 0.01 wt % to about 2 wt % or from about 0.01 wt % to about 0.5 wt %.

Example antimicrobial agents can include the NUOSEPT® (Ashland Inc., USA). VANCIDE® (R.T. Vanderbilt Co., USA), ACTICIDE® B20 and ACTICIDE® M20 (Thor Chemicals, U.K.), PROXEL® GXL (Arch Chemicals, Inc., USA), BARDAC® 2250, 2280, BARQUAT® 50-65B, and CARBOQUAT® 250-T, (Lonza Ltd. Corp., Switzerland), KORDEK® MLX (The Dow Chemical Co., USA), and combinations thereof. In some examples, if included, a total amount of antimicrobial agents in the metallic binding agent, the polymeric binding agent, and/or other fluid agents can range from about 0.01 wt % to about 1 wt %.

In some examples, an aqueous liquid vehicle may further include buffer solution(s). The buffer solution(s) can withstand small changes (e.g., less than 1) in pH when small quantities of a water-soluble acid or a water-soluble base are added to a composition containing the buffer solution(s). The buffer solution(s) can have pH ranges from about 5 to about 9.5, from about 7 to about 9, or from about 7.5 to about 8.5. In some examples, the buffer solution(s) can include a poly-hydroxy functional amine. In other examples, the buffer solution(s) can include potassium hydroxide, 2-[4-(2-hydroxyethyl) piperazin-1-yl] ethane sulfonic acid, 2-amino-2-(hydroxymethyl)-1,3-propanediol (TRIZMA® sold by Sigma-Aldrich, USA), 3-morpholinopropanesulfonic acid, triethanolamine, 2-[bis-(2-hydroxyethyl)-amino]-2-hydroxymethyl propane-1,3-diol (bis tris methane), N-methyl-D-glucamine, N,N,N′N′-tetrakis-(2-hydroxyethyl)-ethylenediamine and N, N, N′N′-tetrakis-(2-hydroxypropyl)-ethylenediamine, beta-alanine, betaine, or mixtures thereof. In other examples, the buffer solution(s) can include 2-amino-2-(hydroxymethyl)-1,3-propanediol (TRIZMA® sold by Sigma-Aldrich, USA), beta-alanine, betaine, or mixtures thereof. The buffer solution, if included, can be added to the metallic binding agent, the polymeric binding agent, and/or other fluid agents at an amount ranging from about 0.01 wt % to about 10 wt %, from about 0.1 wt % to about 7.5 wt %, or from about 0.05 wt % to about 5 wt %.

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 10%, or, in one aspect within 5%, of a stated value or of a stated limit of a range. The term “about” when modifying a numerical range is also understood to include as one numerical subrange a range defined by the exact numerical value indicated, e.g., the range of about 1 wt % to about 5 wt % includes 1 wt % to 5 wt % as an explicitly supported sub-range.

As used herein, “applying” when referring to a fluid agent, such as a fusing agent that may be used, for example, refers to any technology that can be used to put or place the fluid, e.g., metallic binding agent, polymeric binding agent, or other fusing agent onto a layer of particulate build material for forming a three-dimensional object. For example, “applying” may refer to a variety of dispensing technologies, including “jetting,” “ejecting.” “dropping.” “spraying,” or the like.

As used herein, “jetting” or “ejecting” refers to the expulsion of fluid agents or other compositions from ejection or jetting architecture, such as ink-jet printheads. Such architecture can be configured to print varying drop sizes such as up to about 20 picoliters, up to about 30 picoliters, or up to about 50 picoliters, etc. Example ranges may include from about 2 picoliters to about 50 picoliters, or from about 3 picoliters to about 12 picoliters.

As used herein, “average” or “D50” when referring to numerical ranges of particle size refers to a number average of the diameter of the particles for spherical particles, or a number average of the volume equivalent sphere diameter for non-spherical particles. The volume equivalent sphere diameter is the diameter of a sphere having the same volume as the particle.

As used herein, a plurality of items, structural elements, compositional elements, and/or materials may be presented in a common list for convenience. However, these lists should be construed as though an individual member of the list is identified as a separate and unique member. Thus, no individual member of such list should be construed as a de facto equivalent of any other member of the same list based on presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of about 1 wt % to about 20 wt % should be interpreted to include the explicitly recited limits of 1 wt % and 20 wt % and to include individual weights such as about 2 wt %, about 11 wt %, about 14 wt %, and sub-ranges such as about 10 wt % to about 20 wt %, about 5 wt % to about 15 wt %, etc.

### EXAMPLES

The following illustrates examples of the present disclosure. Numerous modifications and alternative compositions, methods, and systems may be devised without departing from the present disclosure. The appended claims are intended to cover such modifications and arrangements.

### Example 1-Preparation of Binding Agents

Two binding agent formulations were prepared by admixing the respective components as shown in Table 1 below.

TABLE 1
Binder Agent Formulations

| | Binding Agents | |
|---|---|---|
| | Metallic | Polymeric |
| | Binding Agent | Binding Agent |
| Component | (wt %) | (wt %) |
| Ammonium Dihydrogen Phosphate | 0.2 | — |
| Acetic Acid | 1 | — |
| Copper Nitrate | 40 | — |
| Surfactant | 0.5 | 0.9 |
| Latex Binder (by solids content) | — | 16 |
| Colorant | — | 0.4 |
| 1,2-Butanediol | — | 12 |
| Deionized Water | Balance | Balance |

### Example 2-Preparation of Three-Dimensional Objects and Support Structures

The binder agent formulations were printed onto particulate build material including 100 wt % of 22 μm sized copper particles (D50 particle size). Multiple three-dimensional printed objects were formed in the shape of a rectangle with an opening, leaving a 15 mm overhang or beam spanning between two vertical posts having a thickness (z-direction) of 1 mm and a width of (y-direction) of 4 mm. One of the objects was printed solely with the metallic binding agent and did not include the printing of a support structure. Other three-dimensional printed objects included metallic binding agent at a central region. Two objects were prepared to be coupled with support structures within the opening of the rectangle to support the overhang or beam during heat fusion. One of the support structures was formed using the polymeric binding agent, and the other support structure was formed using both the polymeric binding agent and the metallic binding agent. Both included polymeric binding agent at the interface between the green body object and the support structure. Where a support structure was used, a 200 μm gap region was left between the support structure and the three-dimensional printed objects. The gap allows some binder to intermix at the interface, but in some examples, there may or may not be a gap left. The support structures were concurrently printed with the green-body objects.

The various green-body objects and support structures (where used) were placed in an atmosphere controlled oven for sintering, e.g., sintering oven with 2.9 wt % ArH₂ or 4 wt % N₂H₂ gas pumped and filled in the oven three times to eliminate all oxygen residue. The oven was heated at 3° C. per minute up to a temperature of 1,000° C. and baked in the oven for 2 hours followed by furnace cooling. During sintering, the copper nitrate in in the metallic binding agent reduced to copper hydroxynitrate and then to copper II oxide at 250° C. and then elemental copper at around 350° C. The elemental copper formed by the hydrogen reduction reaction metallurgically bonded the copper particles of the build material to one another. The early bonding provides faster diffusion than would occur during sintering of the copper particles of the particulate build material.

Where there was polymeric binder present at an interface between the support structure and the fused metal object, a thin carbon layer formed where the two structures contacted one another during the heat fusion process. This carbon layer was formed as a residue from the polymer binder of the polymeric binding agent as the polymer burned during the sintering process. The carbon layer was low density, flaky, and easily airborne in nature. The support structures with this interface were easily removed by exerting a slight amount of mechanical force using a bare hand with a pushing action on the support structure.

Three-dimensional printed objects that did not include this support structure underwent significant deflection at the overhang by more than 11° across the overhang or beam of the rectangle. The three-dimensional printed object that was coupled with the support structure prepared using the polymeric binding agent without metallic binding agent exhibited a minor amount of visible deflection, e.g., about 2°, across the upper beam of the fused metal rectangular object. The three-dimensional printed object that was coupled with the support structure prepared using both the polymeric binding agent and the metallic binding agent did not exhibit any visible deflection across the upper beam of the fused metal rectangular object.

What is claimed is:

1. A method of three-dimensional printing, comprising:
iteratively applying a particulate build material including from about 80 wt % to about 100 wt % metal particles as individual build material layers, wherein the metal particles have a heat fusion temperature;
based on a 3D object model, iteratively and selectively applying a metallic binding agent onto the individual build material layers so that the individual build material layers are built up and bound together to form a green-body object, wherein the metallic binding agent includes an aqueous liquid vehicle and metal salt or metal oxide nanoparticles that are thermally reducible to a metal or metal alloy at an elevated metal reducing temperature that is lower than the heat fusion temperature; and
based on the 3D object model, iteratively and selectively applying a polymeric binding agent onto the individual build material layers at an interface between the green-body object and a support structure for the green-body object, wherein the polymeric binding agent includes an aqueous liquid vehicle and polymer binder that decomposes to form a residue at an elevated polymer decomposition temperature that is lower than the heat fusion temperature, and wherein the residue forms at the interface between the support structure and the green-body object.

2. The method of claim 1, wherein based on the 3D object model, the support structure is formed by iteratively and selectively applying the metallic binding agent, the polymeric binding agent, or both onto the individual build material layers.

3. The method of claim 1, wherein the metallic binding agent is applied to form the green-body object and the support structure, and wherein the polymeric binding agent is applied at the interface at a boundary of the green-body object, the support structure, or both.

4. The method of claim 1, wherein the metallic binding agent is applied to form the green-body object, and wherein the polymeric binding agent is applied to form the support structure.

5. The method of claim 1, further comprising heat fusing the green-body object with the support structure at a temperature at or above the heat fusion temperature ranging from about 500° C. to about 3,200° C. to form a heat fused metal object, wherein the residue at the interface provides that the support structure is not integrated with the heat fused metal object or the support structure is removable from attachment to the heat fused metal object.

6. The method of claim 5, wherein the heat fusing occurs in a controlled atmosphere of vacuum, a gas other than air, or both, wherein when the gas is present, it includes a gas selected from argon, argon-hydrogen mixture, nitrogen-hydrogen mixture, diazene, helium, hydrogen, nitrogen, or a mixture thereof.

7. The method of claim 1, wherein the support structure is printed separately from the green-body object, and the method further comprises assembling the support structure with the green-body object for heat fusion of the green-body object with the support structure at a temperature at or above the heat fusion temperature ranging from about 500° C. to about 3,200° C. to form a heat fused metal object.

8. The method of claim 1, wherein the metal salt or metal oxide nanoparticles are present at from about 20 wt % to about 65 wt % in the metallic binding agent and the metal salt or metal oxide nanoparticles include aluminum oxide, cerium oxide, chromium oxide, copper chloride, copper nitrate, copper nitrite, copper oxide, iron oxide, lanthanum oxide, manganese oxide, magnesium oxide, niobium oxide, silicon dioxide, silver oxide, tin oxide, titanium oxide, yttrium oxide, zinc oxide, zirconium dioxide, or a mixture thereof.

9. The method of claim 1, wherein the polymer binder is present at from about 1 wt % to about 25 wt % in the polymeric binding agent, and wherein the polymer binder includes latex particles selected from acrylate-containing latex, methacrylate-containing latex, styrene-containing latex, polyurethane latex, or a mixture thereof.

10. A three-dimensional printed object and support structure, comprising
a three-dimensional printed object comprising multiple fused metal particle layers with metal salt or metal oxide nanoparticles alloyed therewith;
a removable support structure attached to a portion of the three-dimensional printed object, wherein the removable support structure also includes multiple fused metal particle layers; and
a residue region at an interface between the support structure and the three-dimensional printed object, wherein the residue region is formed from decomposition of a polymer binder at an elevated polymer decomposition temperature that is lower than a heat fusion temperature of metal particles used to form the multiple fused metal particle layers.

11. The three-dimensional object and support of claim 10, wherein the three-dimensional printed object includes an overhang supported by the removable support structure, the overhang having a deformation compared to a green body object used to form the three-dimensional printed object that is less than 3° of deflection.

12. The three-dimensional object and support of claim 10, wherein the fused metal particle layers include elemental metals or metal alloys of chromium, cobalt, copper, iron, magnesium, molybdenum, nickel, niobium, steel, stainless steel, tantalum, tin, titanium, tungsten, zinc, zirconium, or a mixture thereof.

13. A non-transitory machine readable storage medium comprising instructions that when executed by a processor, cause the processer to:
determine layers of a support structure for a three-dimensional printed object and layers of a three-dimensional printed object;
generate instructions to iteratively and selectively apply a metallic binding agent onto the individual build material layers of the three-dimensional printed object so that the individual build material layers are built up and bound together to form a green-body object; and
generate instructions to iteratively and selectively apply a polymeric binding agent onto the individual build material layers at an interface between the green-body object and a support structure for the green-body object.

14. The non-transitory machine readable storage medium of claim 13, wherein the instructions occur based on a computer generated three-dimensional object model and the instructions include calculating a dispensing volume of the metallic binding agent and the polymeric binding agent to be applied onto a particulate build material at locations based on the three-dimensional object model.

15. The non-transitory machine readable storage medium of claim 13, wherein the processor further generates instructions to iteratively and selectively apply the metallic binding agent to a central portion of the support structure.
